(19) United States
(12) Patent Application Publication
(10) Pub. No.: US 2018/0164985 A1
(43) Pub. Date: Jun. 14, 2018

(54) STRING SELECTION METHOD, STORAGE MEDIUM STORING PROGRAM, AND INFORMATION PROCESSING DEVICE

(71) Applicant: FUJITSU LIMITED, Kawasaki-shi (JP)

(72) Inventor: Hiroshi TANAKA, Ota (JP)

(73) Assignee: FUJITSU LIMITED, Kawasaki-shi (JP)

(21) Appl. No.: 15/890,535

(22) Filed: Feb. 7, 2018

Related U.S. Application Data
(63) Continuation of application No. PCT/JP2015/073278, filed on Aug. 19, 2015.

(51) Int. Cl. G06F 3/0484

(52) U.S. Cl. CPC G06F 3/04842; G06F 2203/04805; G06F 3/04845

(57) ABSTRACT

A string selection method includes: by a processor, displaying an image containing a character image on a first display section; in a case in which a first string included in the character image displayed on the first display section has been designated, displaying on a second display section an enlarged image of a first string image that includes the first string; and in a case in which a second string included in the enlarged image displayed on the second display section has been designated, selecting a third string that includes the designated second string from the image displayed on the first display section.

### CROSS-REFERENCE TO RELATED APPLICATION

This application is a continuation application of International Application No. PCT/JP2015/073278, filed Aug. 19, 2015, the disclosure of which is incorporated herein by reference in its entirety.

### FIELD

The embodiments discussed herein are related to a string selection method, a non-transitory storage medium storing a program, and an information processing device.

### BACKGROUND

Related technology exists in which a string is selected by selecting a point on a string. In this technology, the string is extracted from around the selected point, and from the extracted string, a determination is made as to whether the string is a string included in a row written vertically (vertical row) or a string included in a row written horizontally (horizontal row). Then, a string is searched for based on being in a vertical row or a horizontal row, and a region surrounding the string is generated from the found string.

However, in the above related technology, from the selected point it is difficult to precisely select the string intended by the user in order to generate the region surrounding the string. To resolve this issue, related technology exists in which, for example, a string is selected by tracing over the string with a designating body such as a finger.

### RELATED PATENT DOCUMENTS

Japanese Patent Application Laid-Open (JP-A) No. H06-089330

### SUMMARY

According to an aspect of the embodiments, a string selection method includes: by a processor, displaying an image containing a character image on a first display section;

in a case in which a first string included in the character image displayed on the first display section has been designated, displaying on a second display section an enlarged image of a first string image that includes the first string; and in a case in which a second string included in the enlarged image displayed on the second display section has been designated, selecting a third string that includes the designated second string from the image displayed on the first display section.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of relevant functionality of an information processing device according to an exemplary embodiment.

FIG. 2 is a block diagram illustrating an example of electrical configuration for an information processing device according to an exemplary embodiment.

FIG. 3 is a flowchart illustrating an example of string selection processing according to an exemplary embodiment.

FIG. 4 is a flowchart illustrating an example of first string selection processing according to a first exemplary embodiment.

FIG. 5 is a schematic diagram illustrating an example of an image that includes a string image according to an exemplary embodiment.

FIG. 6 is a schematic diagram illustrating an example of a string image according to an exemplary embodiment.

FIG. 7 is a schematic diagram illustrating an example of character boxes according to an exemplary embodiment.

FIG. 8 is a schematic diagram illustrating an example of a string box according to an exemplary embodiment.

FIG. 9 is a schematic diagram illustrating an example of an initial string box according to an exemplary embodiment.

FIG. 10 is a schematic diagram illustrating an enlarged display section according to the first exemplary embodiment.

FIG. 11 is a flowchart illustrating an example of second string selection processing according to the first exemplary embodiment.

FIG. 12 is a schematic diagram illustrating an example of second string designation according to the first exemplary embodiment.

FIG. 13 is a schematic diagram for explaining coordinate conversion between a position in an enlarged display section and a position in a normal display section according to the first exemplary embodiment.

FIG. 14A is a flowchart illustrating an example of part of first string selection processing according to a second exemplary embodiment.

FIG. 14B is a flowchart illustrating an example of second string selection processing according to the second exemplary embodiment.

FIG. 15A is a schematic diagram illustrating an example of a first string enlargement image according to the second exemplary embodiment.

FIG. 15B is a schematic diagram illustrating an example of a first string enlargement image displayed in an enlarged display section according to the second exemplary embodiment.

FIG. 15C is a schematic diagram illustrating an example of second string designation in an enlarged display section according to the second exemplary embodiment.

FIG. 15D is a schematic diagram illustrating an example of second string designation in an enlarged display section according to the second exemplary embodiment.

FIG. 16 is a schematic diagram for explaining coordinate conversion between a position in an enlarged display section and a position in a normal display section according to the second exemplary embodiment.

### DESCRIPTION OF EMBODIMENTS

### First Exemplary Embodiment

Exemplary embodiments of technology disclosed herein are described in detail below, with reference to the drawings. Note that although in the following explanation a smart device is given as an example of an information processing device according to technology disclosed herein, the exemplary embodiments are not limited thereto. Application of the exemplary embodiments may be made using various information processing devices, such as a tablet computer, a mobile phone, or an electronic dictionary.

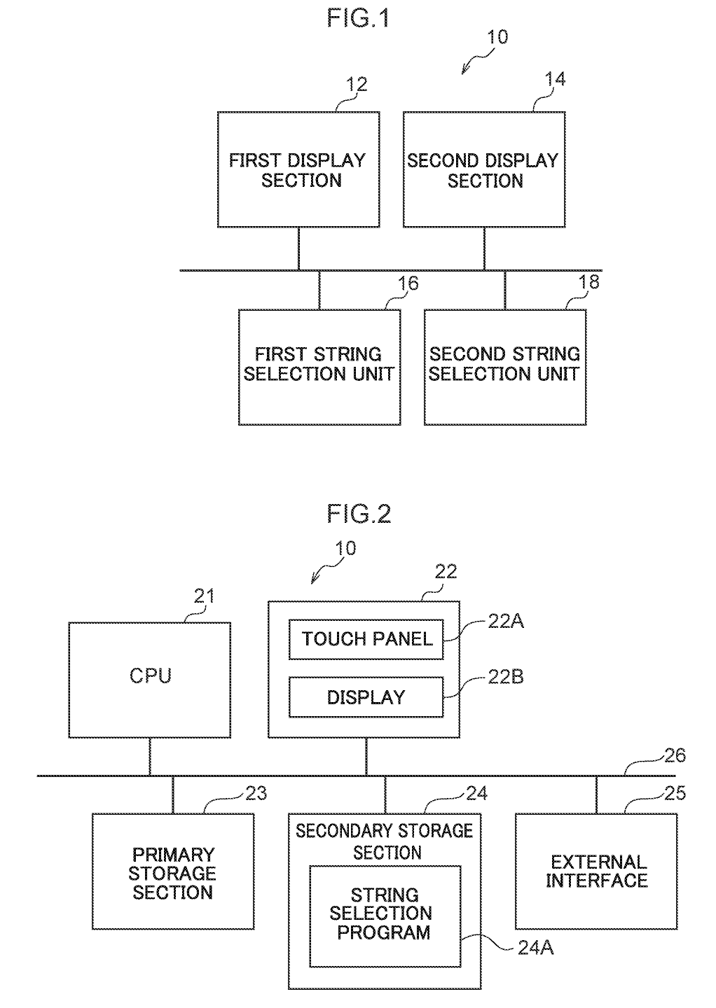

A smart device 10 is illustrated in the example of FIG. 1. The smart device 10 includes, for example, a first display section 12, a second display section 14, a first string selection unit 16, and a second string selection unit 18. The first display section 12, the second display section 14, the first string selection unit 16, and the second string selection unit 18 are connected together.

The first display section 12 displays an image that contains a character image. In cases in which a first string included in the character image displayed on the first display section 12 has been designated, the second display section 14 displays an enlarged image of the first string image that includes the first string. In cases in which a second string included in the enlarged image displayed on the second display section has been designated, the second string selection unit 18, which is an example of a string selection unit, selects a third string that includes the designated second string from the image displayed on the first display section.

The smart device 10 includes, as illustrated in the example of FIG. 2, a central processing unit (CPU) 21, a primary storage section 23, a secondary storage section 24, an external interface 25, and a touch panel display 22. The CPU 21, the primary storage section 23, the secondary storage section 24, the external interface 25, and the touch panel display 22 are connected together via a bus 26.

The touch panel display 22 includes a touch panel 22A and a display 22B. The touch panel 22A detects information that has been input by a user and displays information to be presented to the user on the display 22B. The display 22B is an example of the first display section 12 and the second display section 14 in FIG. 1. The external interface 25 is connected to an external device, and governs the exchange of a variety of information between the external device and the CPU 21.

The primary storage section 23 is, for example, volatile memory such as random-access memory (RAM). The secondary storage section 24 is, for example, non-volatile memory such as a hard disk drive (HDD) or a solid state drive (SSD). The secondary storage section 24 stores, for example, a string selection program 24A.

The CPU 21 reads out the string selection program 24A from the secondary storage section 24 and expands the string selection program 24A into the primary storage section 23. The CPU 21 executes the string selection program 24A so as to operate as the first string selection unit 16 and the second string selection unit 18 illustrated in FIG. 1.

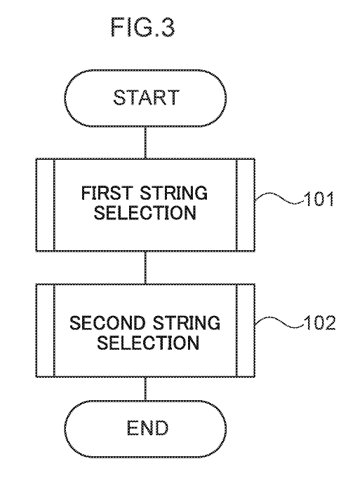

Next, operation of the present exemplary embodiment is explained with regards to string selection processing implemented by the smart device 10. FIG. 3 illustrates an example of string selection processing implemented by the smart device 10.

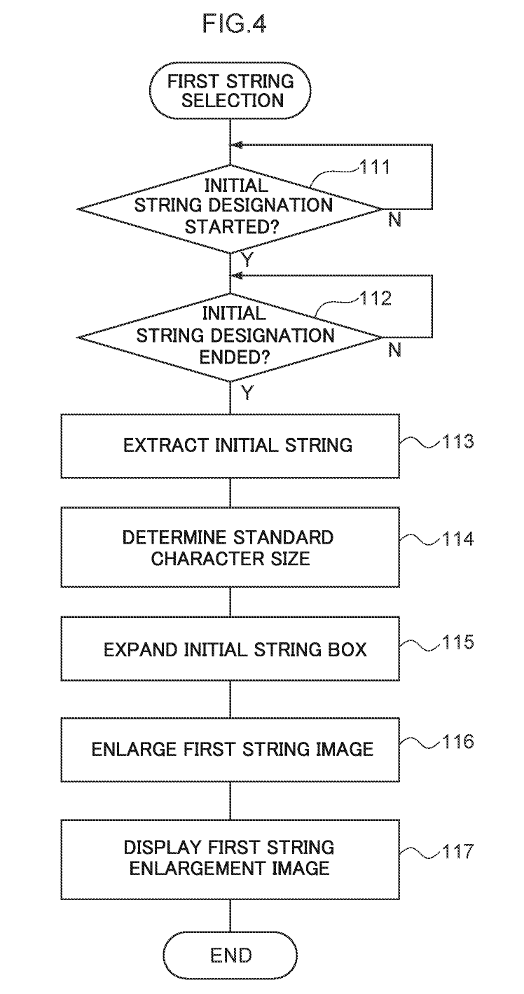

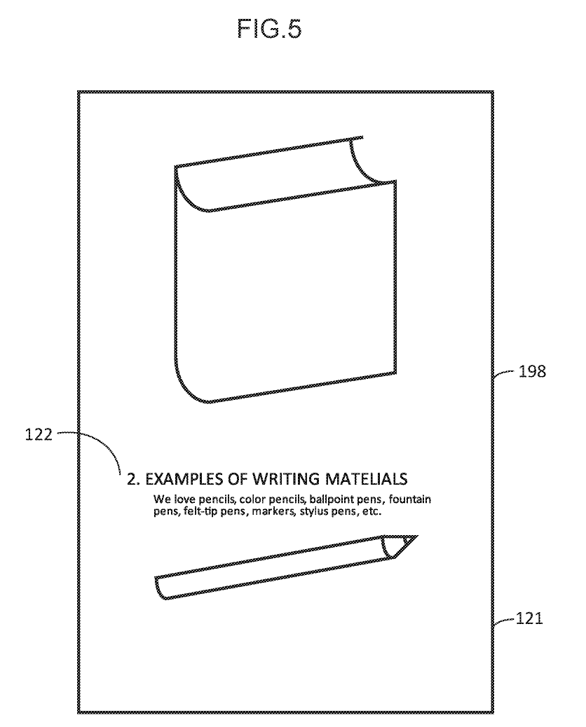

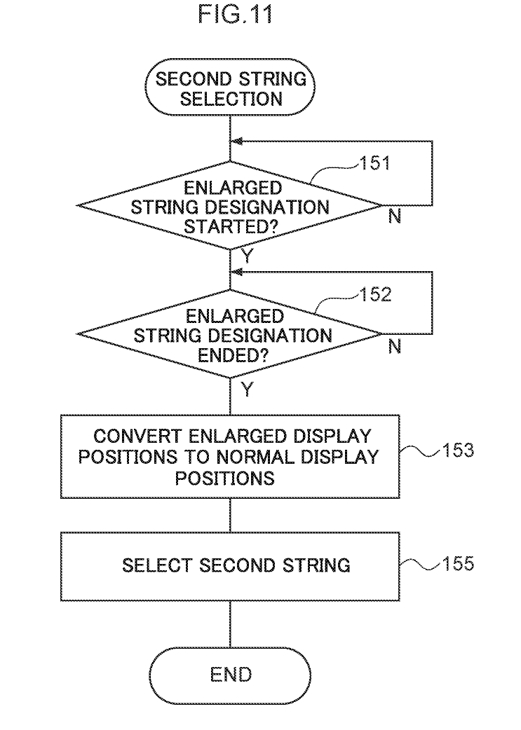

In cases in which an image 121 that contains a character image 122 such as that illustrated in FIG. 5 is being displayed on the touch panel display 22, the string selection processing of FIG. 3 starts when the user performs a predetermined touch gesture on the touch panel display 22. At step 101, the CPU 21 executes first string selection processing such as that illustrated in detail in FIG. 4, and at step 102 the CPU 21 executes second string selection processing such as that illustrated in in detail in FIG. 11.

In the string selection processing of the present exemplary embodiment, rough selection of a string from an image displayed on the first display section for normal display is performed by first string selection processing, and precise selection of a string from an image displayed on the second display section for enlarged display is performed by second string selection processing.

Detailed explanation follows regarding first string selection processing at step 101 in FIG. 3, with reference to FIG. 4. At step 111, the CPU 21 makes a determination as to whether or not designation of an initial string, which is an example of a first string, has started on a normal display section 198, which is an example of the first display section. The CPU 21 repeats the determination processing of step 111 until an affirmative determination is made at step 111. The CPU 21 determines that designation of an initial string has started when, for example, a designating body such as a finger is detected to made contact with the touch panel display 22.

When an affirmative determination has been made at step 111, at step 112, the CPU 21 makes a determination as to whether or not designation of the initial string has ended. The CPU 21 repeats the determination processing of step 112 repeated until an affirmative determination is made at step 112. The CPU 21 determines that string designation has ended when, for example, the designating body is detected to have come away from the touch panel display 22.

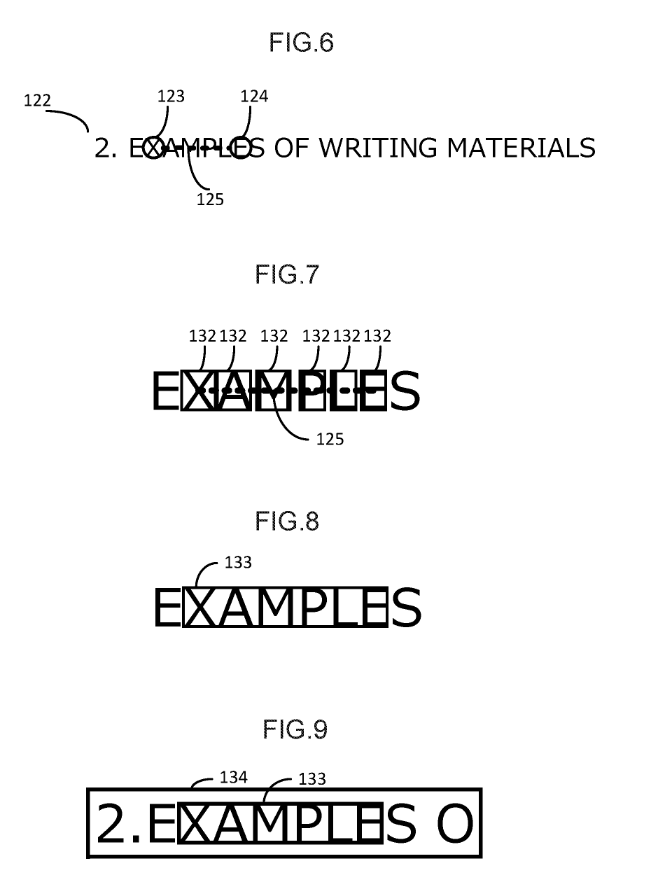

FIG. 6 illustrates an example of a starting point 123 where a designating body makes initial contact with the touch panel display 22, and of an ending point 124 where the designating body comes away from the touch panel display 22. The dashed line indicates a trajectory 125 traced by the designating body moving over the touch panel display 22 while making contact with the touch panel display 22.

At step 113, the CPU 21 extracts the initial string. In more detail, as illustrated in FIG. 7, the CPU 21 surrounds each of the characters overlapping with the trajectory 125, and extracts each character within character boxes 132 that circumscribe the characters. Next, as illustrated in FIG. 8, the CPU 21 extracts, as the initial string, a string included in a single string box 133 that encompasses all of the extracted character boxes 132. In this example, the initial string is “XAMPLE”.

At step 114, the CPU 21 determines a standard character size S for all the characters included in the extracted initial string. The standard character size S is, for example, determined using Equation (1) as follows:

$$S = \frac{1}{N} {\sum }_{i = 1}^{N} max ( {h}_{i} , {w}_{i} ) \qquad ( 1 )$$

In this example, hᵢ is the height of the i^{th} character box 132, wᵢ is the width of the i^{th} character box 132, N is the number of character boxes 132, and i=1, 2, 3, . . . , N. The standard character size S is thus the average value of the longer of the height and width for each of the character boxes 132. Note that there is no limitation to using an average value in the present exemplary embodiment, and for example, the standard character size S may, from out of N character boxes 132, be the maximum length of the longer of height and width for the character boxes 132.

Next, at step 115, the CPU 21 expands the string box 133, which is an example of an initial string box, so as to create a first string box 134. In more detail, the CPU 21, for example, expands the width of the string box 133 by 3×S both directly before and directly after the string included in the string box 133, and expands the height of the string box 133 by 0.5×S both above and below the string.

Note that to create the first string box 134, it is sufficient to expand the string box 133 such that at least one character can be added both directly before and directly after the string included in the string box 133. For example, the width of the string box 133 may be expanded by 4×S both directly before and directly after the string included in the string box 133, or the width of the string box 133 may be expanded by a predetermined number of pixels, for example 30 pixels, both directly before and directly after the string included in the string box 133.

To create a first string box 134, the string box 133 may be expanded so as encompass a first string made by adding at least one character either directly before or directly after the string included in the string box 133. Alternatively, configuration may be such that neither the width nor height of the string box 133 is expanded. FIG. 9 illustrates an example in which a first string box 134 has been created by expanding both the width and the height of a string box 133.

Further, an amount to expand the first string box 134 from the string box 133 may, for example, be determined based on the speed that the designating body traces the trajectory 125, namely, the speed of movement when the designating body moves while making contact with the touch panel display 22. For example, the amount of expansion may be made to increase as the tracing speed of the designating body increases. In general, as tracing speed increases, the possibility that a string has not been designated as intended by the user becomes higher. For example, when the length of the trajectory 125 is 200 pixels and the trajectory 125 has traced from the starting point 123 to the ending point 124 in 0.5 seconds, the average tracing speed is 200 pixels/0.5 seconds=400 pixels/sec. Note that the amount of expansion may be increased by a predetermined amount in cases in which the tracing speed exceeds a predetermined speed.

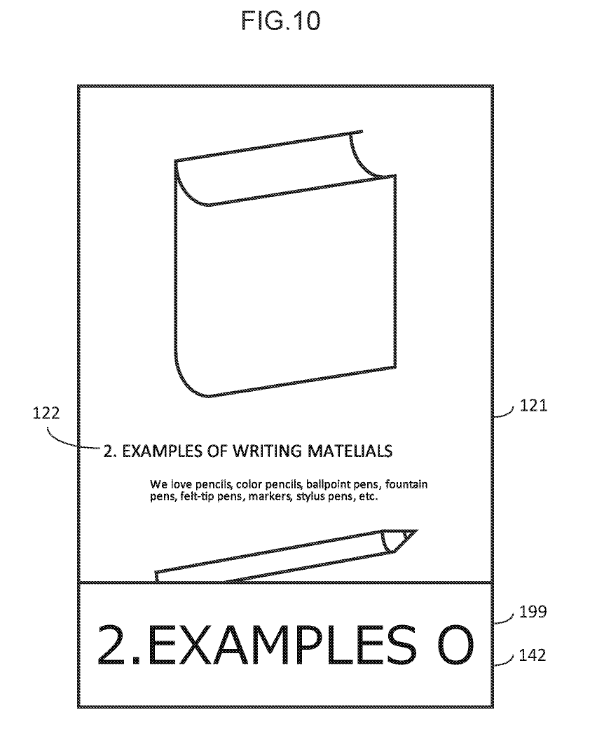

Next, at step 117, the CPU 21 displays a first string enlargement image 142, as illustrated in FIG. 10, in an enlarged display section 199, which is an example of a second display section. For example, an enlargement ratio R from the first string box 134 to the first string enlargement image 142, which is used to create the first string enlargement image 142, is determined according to Equation (2) as follows:

i R=M/S (2)

In this example, M is the character size of characters included in the first string enlargement image 142. M is set in advance to a desired character size.

Next, detailed explanation follows regarding the second string selection 102 processing in FIG. 3, with reference to FIG. 11. At step 151, the CPU 21 makes a determination as to whether or not string designation on the enlarged display section 199 has started. The determination of step 151 is repeated until an affirmative determination is made at step 151. The CPU 21 determines that the designation of a string in the first string enlargement image 142 has started when, for example, a designating body is detected to made contact with the touch panel display 22.

When an affirmative determination has been made at step 151, at step 152, the CPU 21 makes a determination as to whether or not string designation has ended. The determination of step 152 is repeated until an affirmative determination is made at step 152. The CPU 21 determines that string designation has ended when, for example, the designating body is detected to have come away from the touch panel display 22.

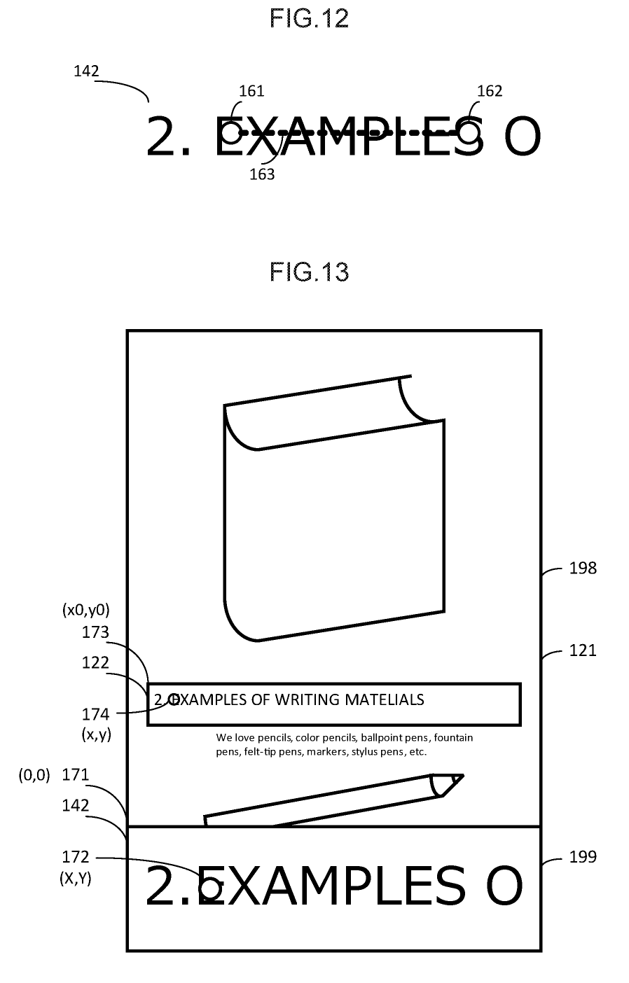

FIG. 12 illustrates an example of a starting point 161 where a designating body makes contact with the touch panel display 22, and of an ending point 162 where the designating body comes away from the touch panel display 22. The dashed line indicates a trajectory 163 traced by the designating body moving over the touch panel display 22 while making contact with the touch panel display 22. The trajectory 163 is an example of a designation of a second string.

When an affirmative determination has been made at step 152, at step 153, the CPU 21 converts coordinates for each of plural second positions, which are points along the trajectory 163 illustrated in FIG. 12 on the enlarged display section 199 illustrated in FIG. 13, to coordinates for first positions on the normal display section 198. String designation by a designating body is performed using the enlarged display section 199, on which character size is enlarged so as to facilitate designation, though the string being designated is the one present on the normal display section 198. The coordinate conversion is, for example, performed using Equation (3-1) and Equation (3-2) as follows:

x=X/R+x0 (3-1)

y=Y/R+y0 (3-2)

In this example, position 171 is the origin (0, 0) for a second position 172 (X, Y), and a position 173 is the origin (x0, y0) for a first position (x, y) corresponding to the second position 172. R expresses the enlargement ratio R, described above, from the first string box 134 to the first string enlargement image 142.

Note that in the normal display section 198, a trajectory corresponding to the trajectory 163 is, for example, displayed based on the converted coordinates of the converted second position 172 using a color with transparency.

Next, at step 155, the CPU 21 selects a second string similarly to at step 113 in FIG. 4. Note that at step 155, a string that includes the characters contained in the character boxes overlapping with a trajectory on the normal display section 198 corresponding to the trajectory 163 acquired at step 153 is selected as the second string. In this example, “EXAMPLES” is selected as the second string.

Note that the selected second string may be converted to text using a known character recognition method and copied to the clipboard for pasting into a desired application.

Note that although an example is given above regarding processing to select a string from an image 121, the present exemplary embodiment is not limited thereto. For example, such processing may also be applied to text displayed in a word processing application. In such cases, there is no need to convert the second string into text using an existing character recognition method.

Further, although an example is given above in which the string is in a horizontal row, the present exemplary embodiment is not limited thereto. For example, the string may be in a vertical row.

Further, although an example is given above in which the string is in English, the present exemplary embodiment is not limited thereto. For example, the string may be in Japanese.

Further, although an example is given above in which an initial selection string is on a single row, the present exemplary embodiment is not limited thereto. For example, the initial selection string may be over two or more rows. In such cases, configuration may be such that plural enlarged display sections 199 are present, one for each row.

Further, although an example is given above in which the enlarged display section 199 is displayed at a bottom portion of the screen of the touch panel display 22, the present exemplary embodiment is not limited thereto. The enlarged display section 199 may be displayed at any position on the screen of the touch panel display 22.

Further, although an example is given above in which a designating body such as a finger traces over a string displayed on the touch panel display 22 to designate the string, the present exemplary embodiment is not limited thereto. For example, the designating body may be a stylus, and configuration may be such that a string is designated by touching the designating body at an upper-left corner and a lower-right corner of a box surrounding a string.

In the present exemplary embodiment, an initial string designated by a user on the normal display section 198 is expanded at the front and rear of the string to give a first string, which is enlarged and displayed on the enlarged display section 199, and a string on the normal display section 198 corresponding to a string designated by the user on the enlarged display section 199 is selected as a second string. The present exemplary embodiment thereby facilitates precise selection of the string intended by the user.

For example, in cases in which the screen is small, such as on a smart device 10, and characters displayed thereon are also small, technology exists to enlarge display over the entire screen for designating a string. However, in such cases, enlarging the display by an appropriate scaling is difficult. For example, when this scaling is too small, it is still difficult to designate a string, and when the scaling is too large, the string a user wants to select is not able to be entirely displayed on the screen, making designation of a string similarly difficult.

Moreover, although among technologies for designating a string, technology exists in which an enlarged display section is displayed on a portion of a screen and an enlarged string is displayed in the enlarged display section, in this technology, a designating body is used over the normal display section, which is not the enlarged display section, to designate a string. The enlarged display section, which displays the string enlarged so as to facilitate viewing by a user, is separated from the normal display section for string designation. This clashes with user intuition, making designation of a string difficult.

Moreover, in cases in which the screen is small, such as on a smart device 10, and characters displayed thereon are also small, an extremely small region needs to be precisely designated when attempting to precisely designate an intended string in one attempt. Accordingly, a high level of concentration is demanded in order to look at the display containing the small characters and precisely operate the designating body so as to precisely designate an extremely small region. Moreover, in cases in which the designating body is a finger or a stylus for a capacitive touch panel, since the leading end thereof is comparatively large, it is difficult to precisely designate an extremely small region even when carefully operating the designating body.

In the present exemplary embodiment, first string selection processing and second string selection processing to designate a string are performed twice, as considered altogether. However, since the first selection is a rough selection and the second selection can be performed by making direct contact with an enlarged display, a high level of concentration is not demanded from the user.

### Second Exemplary Embodiment

Next, explanation follows regarding a second exemplary embodiment, which is another example of technology disclosed herein. Explanation of configuration and operation similar to that of the first exemplary embodiment is omitted.

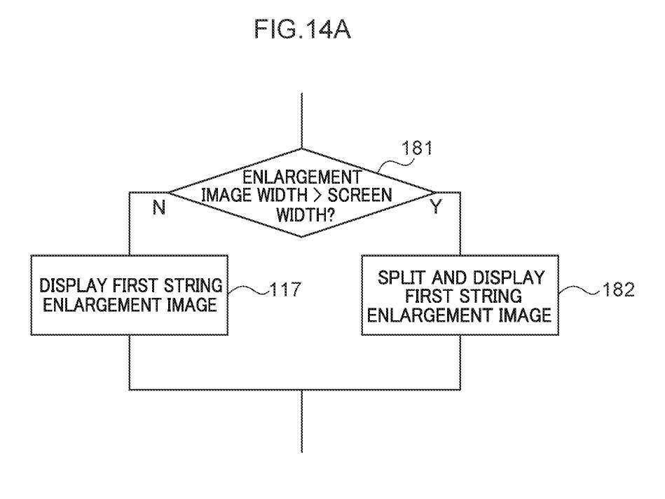

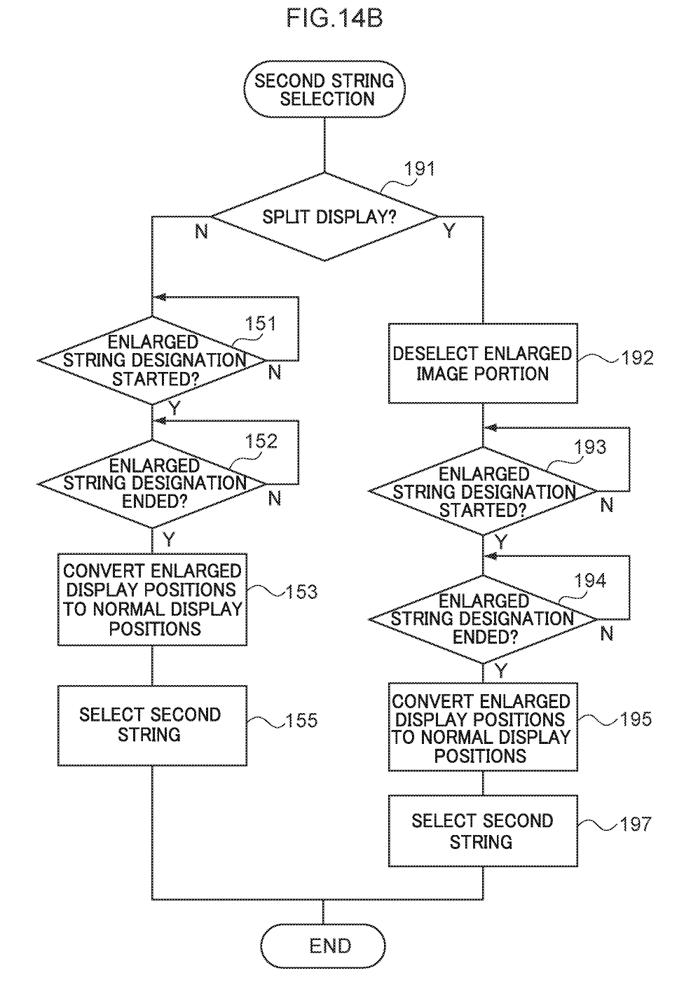

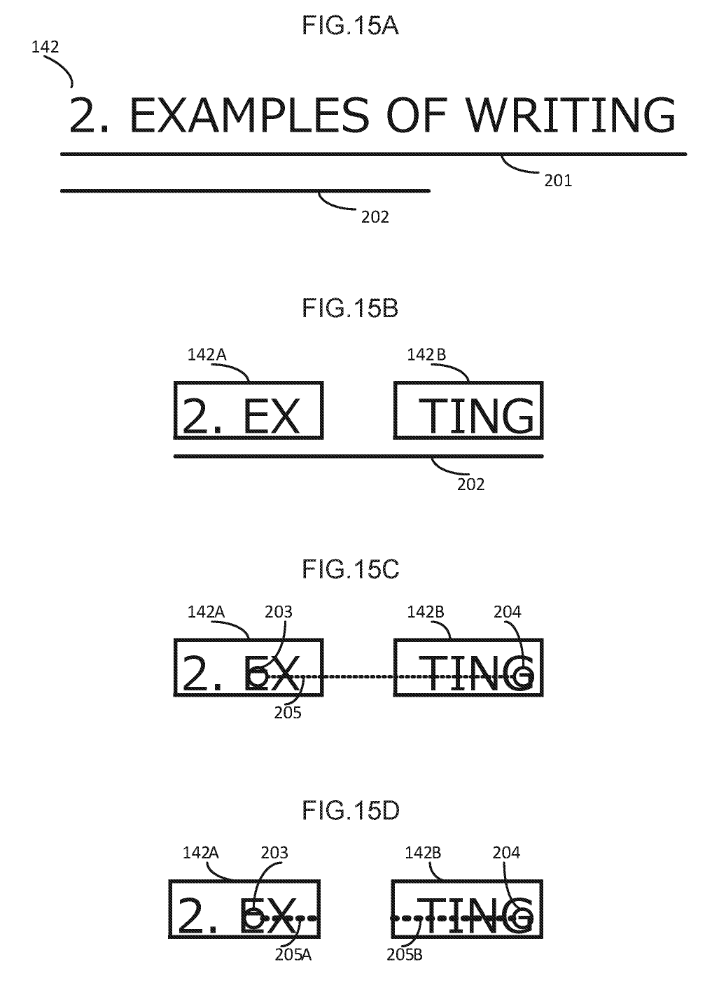

As illustrated in FIG. 15A, explanation of operation of the second exemplary embodiment includes cases in which a width 201 of a first string enlargement image 142 exceeds a screen width 202 of the touch panel display 22. In the second exemplary embodiment, step 117 of FIG. 4 is replaced by steps 181, 117, and 182 in FIG. 14A.

At step 181, the CPU 21 makes a determination as to whether or not the width 201 of the first string enlargement image 142 has exceeded the screen width 202. In cases in which a negative determination has been made, the processing of step 117, explained in the first exemplary embodiment, is executed. However, in cases in which an affirmative determination has been made, at step 182, the CPU 12 splits the first string enlargement image 142 as illustrated in FIG. 15B for display on the enlarged display section 199.

In more detail, a leading portion 142A and a trailing portion 142B of the first string enlargement image 142 are displayed on the expanded display section 199. The portion of the first string enlargement image 142 between the leading portion 142A and the trailing portion 142B is not displayed. This is because, in the second round of string designation in the second string selection processing, it is important to increase the precision of string designation at the leading portion 142A and at the trailing portion 142B of a string, which is an example of an expanded string. For example, an enlarged image corresponding to a leading length L×S portion of a first string may be included in the leading portion 142A, and an enlarged image corresponding to a trailing length L×S portion of the first string may be included in the trailing portion 142B. Herein, S is the standard character size as described above, and L may, for example, be any integer from 2 to 4. However, L is not limited to being an integer from 2 to 4, and may be an integer greater than or equal to 5.

FIG. 14B illustrates an example of second string selection processing. At step 191, the CPU 21 makes a determination as to whether or not the first string enlargement image 142 is being displayed after having been split. In cases in which a negative determination has been made, processing transitions to step 151. The processing of step 151 to step 155 is similar to that executed in the first exemplary embodiment, and so explanation thereof is omitted.

In cases in which an affirmative determination has been made at step 191, at step 192, the CPU 21 deselects the leading portion 142A and trailing portion 142B of the first string enlargement image 142. For example, consider the case in which, as illustrated in FIG. 15A, “2. EXAMPLES OF WRITING” is selected as the first string, and as illustrated in FIG. 15B, the leading portion 142A includes “2. EX” and the trailing portion 142B includes “TING”. In this case, “2. EX” and “TING” would be deselected from the first string, and only “AMPLES OF WRI” would still be selected as the first string.

At step 193, the CPU 21 makes a determination as to whether or not the string designation has started on the enlarged display section 199. The determination of step 193 is repeated until an affirmative determination is made at step 193. The CPU 21 determines that designation of an enlarged string has started when, for example, a designating body is initially detected to have made contact with the touch panel display 22.

When affirmative determination is made at step 193, at step 194, the CPU 21 makes a determination as to whether or not string designation on the enlarged display section 199 has ended. The determination of step 194 is repeated until an affirmative determination is made at step 194. The CPU 21 determines that the string designation has ended when, for example, the designating body is detected to have come away from the touch panel display 22.

FIG. 15C illustrates an example of a starting point 203 where a designating body makes contact with the touch panel display 22, and of an ending point 204 where the designating body comes away from the touch panel display 22. The dashed line indicates a trajectory 205 traced by the designating body over the touch panel display 22.

When an affirmative determination has been made at step 194, at step 195, the CPU 21 converts coordinates for each of plural second positions, which are points along the trajectory 205 designating a string on the enlarged display section 199, to coordinates for first positions on the normal display section 198. In more detail, the coordinates for each of the second positions along a trajectory 205A included in the leading portion 142A and along a trajectory 205B included in the trailing portion 142B illustrated in FIG. 15D are converted to coordinates for first positions on the normal display section 198. String designation is performed using the enlarged display section 199, on which character size is enlarged so as to facilitate designation, though the string being designated is the one present on the normal display section 198. The coordinate conversion is, for example, performed using Equation (4-1) to Equation (4-4) as follows:

x=X/R+x0 (4-1)

y=Y/R+y0 (4-2)

z=Z/R+z0 (4-3)

u=U/R+u0 (4-4)

In this example, position 171A is the origin (0, 0) for a second position 172A (X,

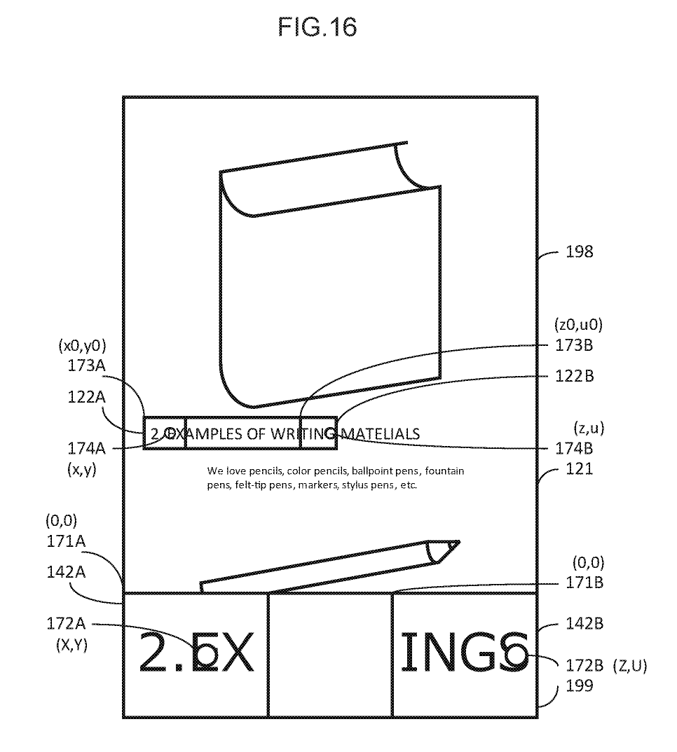

Y) illustrated in FIG. 16, and a position 171B is the origin (0, 0) for a second position 172B (Z, U) illustrated in FIG. 16. Further, a position 173A is the origin (x0, y0) for a first position 174A (x, y) corresponding to the second position 172A, and a position 173B is the origin (z0, u0) for a first position 174B (z, u) corresponding to the second position 172B. R expresses the enlargement ratio from the first string box 134 to the first string enlargement image 142 as described above.

Next, at step 197, the CPU 21 selects the leading portion and the trailing portion of the second string similarly to at step 113 in FIG. 4. Note that at step 197, strings that include the characters contained in the character boxes overlapping with a trajectory on the normal display section 198, respectively corresponding to the trajectory 205A and the trajectory 205B acquired at step 195, are selected as the leading portion and the trailing portion of the second string. In this example, “EX” is selected as the leading portion of the second string, and “TING” is selected as the trailing portion of the second string.

Next, at step 192, the portion of the first string that was not deselected is joined with the leading portion and the trailing portion of the second string, and the second string is selected. In this example, “AMPLES OF WRI” is joined with “EX” and “TING” and “EXAMPLES OF WRITING” is selected as the second string.

Note that although FIG. 15B and FIG. 15C illustrate an example in which the leading portion 142A and the trailing portion 142B of the first string enlargement image 142 are displayed spaced apart from each other, the present exemplary embodiment is not limited thereto, and the leading portion 142A and the trailing portion 142B may be directly adjacent to each other.

In the present exemplary embodiment, an initial string designated by a user on the normal display section 198 is expanded at the front and rear to give a first string, which is enlarged and displayed on the enlarged display section 199, and then a string on the normal display section 198 corresponding to a string designated by the user on the enlarged display section 199 is selected as a second string. The present exemplary embodiment thereby facilitates precise selection of a string intended by the user.

In the present exemplary embodiment, first string selection processing and second string selection processing to designate a string are performed twice, as considered altogether. However, since the first round of selection is a rough selection and the second round of selection can be performed by making direct contact with an enlarged display, a high level of concentration is not demanded from the user.

In the present exemplary embodiment, in cases in which a width 201 of a first string enlargement image 142 exceeds a width 202 of a touch panel display screen, only a leading portion 142A and a trailing portion 142B of the first string, which serve important roles in the selection of a second string, are displayed on the enlarged display section 199. The first string is an example of an expanded string.

Accordingly, even in cases in which a long first string has been selected, the size of characters included in the first string enlargement image 142 are able to be kept to a size that facilitates viewing and designation operations by a user. This facilitates precise selection of a string intended by the user.

In related arts, for example, in a case in which a screen is small, such as on a smart device, and characters displayed thereon are also small, it may be difficult to precisely select the string intended by a user by tracing over a string with a designating body.

According to the present disclosure, the precise selection of a string intended by a user can be facilitated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A string selection method comprising:
by a processor,
displaying an image containing a character image on a first display section;
in a case in which a first string included in the character image displayed on the first display section has been designated, displaying on a second display section an enlarged image of a first string image that includes the first string; and
in a case in which a second string included in the enlarged image displayed on the second display section has been designated, selecting a third string that includes the designated second string from the image displayed on the first display section.

2. The string selection method of claim 1, wherein:
displaying the enlarged image of the first string image on the second display section includes:
expanding an initial string box circumscribing the first string so as to encompass an expanded string having at least one character added at least at one of directly before or directly after the first string so as to create a first string box, and displaying on the second display section an enlarged image of the first string image included in the first string box, and
determining an amount of expansion in a case of expanding from the initial string box to the first string box based on a size of a character included in the first string.

3. The string selection method of claim 2, wherein:
the first string is designated by a designating body moving over the first string while the designating body makes contact with the first display section; and
the amount of expansion in the case of expanding from the initial string box to the first string box is determined based on a movement speed of the designating body in a case of designating the first string.

4. The string selection method of claim 2, wherein:
the enlarged image includes a first enlarged image that includes a leading string in the expanded string, and includes a second enlarged image that includes a trailing string in the expanded string.

5. A non-transitory storage medium storing a program that is executable by a computer to perform string selection processing, the string selection processing comprising:
displaying an image containing a character image on a first display section;
in a case in which a first string included in the character image displayed on the first display section has been designated, displaying on a second display section an enlarged image of a first string image that includes the first string; and
in a case in which a second string included in the enlarged image displayed on the second display section has been designated, selecting a third string that includes the designated second string from the image displayed on the first display section.

6. The non-transitory storage medium of claim 5, wherein:
displaying the enlarged image of the first string image on the second display section includes:
expanding an initial string box circumscribing the first string so as to encompass an expanded string having at least one character added at least at one of directly before or directly after the first string so as to create a first string box, and displaying on the second display section an enlarged image of the first string image included in the first string box, and
determining an amount of expansion in a case of expanding from the initial string box to the first string box based on a size of a character included in the first string.

7. The non-transitory storage medium of claim 6, wherein:
the first string is designated by a designating body moving over the first string while the designating body makes contact with the first display section; and
the amount of expansion in the case of expanding from the initial string box to the first string box is determined based on a movement speed of the designating body in a case of designating the first string.

8. The non-transitory storage medium of claim 6, wherein:
the enlarged image includes a first enlarged image that includes a leading string in the expanded string, and includes a second enlarged image that includes a trailing string in the expanded string.

9. An information processing device comprising:
a first display section that displays an image containing a character image;
a second display section that, in a case in which a first string included in the character image displayed on the first display section has been designated, displays an enlarged image of a first string image that includes the first string;
a memory; and
a processor that is connected to the first display section, the second display section and the memory and that is configured to:
in a case in which a second string included in the enlarged image displayed on the second display section has been designated, select a third string that includes the designated second string from the image displayed on the first display section.

10. The information processing device of claim 9, wherein:
the processor is further configured to:
expand an initial string box circumscribing the first string so as to encompass an expanded string having at least one character added at least at one of directly before or directly after the first string so as to create a first string box, and display on the second display section an enlarged image of the first string image included in the first string box, and
determine an amount of expansion in a case of expanding from the initial string box to the first string box based on a size of a character included in the first string.

11. The information processing device of claim 10, wherein:
the first string is designated by a designating body moving over the first string while the designating body makes contact with the first display section; and
the processor is further configured to:
determine the amount of expansion in the case of expanding from the initial string box to the first string box based on a movement speed of the designating body in a case of designating the first string.

12. The information processing device of claim 10, wherein:
the enlarged image includes a first enlarged image that includes a leading string in the expanded string, and includes a second enlarged image that includes a trailing string in the expanded string.
